(19) United States
(12) Patent Application Publication
(10) Pub. No.: US 2026/0051612 A1
(43) Pub. Date: Feb. 19, 2026

(54) BATTERY PACK VENTING SYSTEM AND VENTING METHOD

(71) Applicant: Ford Global Technologies, LLC, Dearborn, MI (US)

(72) Inventors: Patrick Roxin, Livonia, MI (US); Bhaskara Rao Boddakayala, Troy, MI (US)

(21) Appl. No.: 18/802,569

(22) Filed: Aug. 13, 2024

(51) Int. Cl. H01M 50/367; H01M 50/249; H01M 50/289; H01M 50/342

(52) U.S. Cl. CPC H01M 50/367; H01M 50/249; H01M 50/289; H01M 50/3425; H01M 2220/20

(57) ABSTRACT

A battery pack venting system includes one or more cell stacks of a traction battery pack; and a vent management member having a divider wall that separates an inner channel of the vent management member from an outer channel of the vent management member. The inner channel opens toward the cell stack. The inner channel is configured to communicate a flow of vent byproducts in a first direction to a position where the flow of vent byproducts can move around the divider wall from the inner channel to the outer channel. The outer channel is configured to communicated the flow of vent byproducts in an opposite, second direction to at least one outlet from the vent management member.

### TECHNICAL FIELD

This disclosure relates generally to traction battery packs and, more particularly, to communicating vent byproducts from battery cells to an area outside the battery pack.

### BACKGROUND

Electrified vehicles include a traction battery pack for powering electric machines and other electrical loads of the vehicle. The traction battery pack can include a plurality of battery cells and various other battery internal components that support electric vehicle propulsion.

### SUMMARY

In some aspects, the techniques described herein relate to a battery pack venting system, including: one or more cell stacks of a traction battery pack; and a vent management member having a divider wall that separates an inner channel of the vent management member from an outer channel of the vent management member, the inner channel opening toward the cell stack, the inner channel configured to communicate a flow of vent byproducts in a first direction to a position where the flow of vent byproducts can move around the divider wall from the inner channel to the outer channel, the outer channel configured to communicated the flow of vent byproducts in an opposite, second direction to at least one outlet from the vent management member.

In some aspects, the techniques described herein relate to a battery pack venting system, wherein the inner channel is disposed between the outer channel and the one or more cell stacks.

In some aspects, the techniques described herein relate to a battery pack venting system, wherein the inner channel is configured to receive a flow of vent byproducts from an area between a pair of cross-member assemblies.

In some aspects, the techniques described herein relate to a battery pack venting system, wherein the vent management member is an extruded structural member.

In some aspects, the techniques described herein relate to a battery pack venting system, wherein the vent management member spans a plurality of cell stacks.

In some aspects, the techniques described herein relate to a battery pack venting system, wherein the vent management member extends longitudinally along a vent management member axis, the first direction and the second direction extending along the vent management member axis.

In some aspects, the techniques described herein relate to a battery pack venting system, further including a first endcap and a second endcap disposed at opposing axial ends of the vent management member, the first endcap and the second endcap each configured to redirect a flow of vent byproducts from the inner channel into the outer channel.

In some aspects, the techniques described herein relate to a battery pack venting system, wherein the inner channel has a C-shaped profile.

In some aspects, the techniques described herein relate to a battery pack venting system wherein the inner channel is inboard the outer channel.

In some aspects, the techniques described herein relate to a battery pack venting system, wherein the outlet is in a vertical bottom side of the vent management member.

In some aspects, the techniques described herein relate to a battery pack venting system, wherein one or more cell stacks are upper tier cell stacks of a multi-tiered battery pack.

In some aspects, the techniques described herein relate to a battery pack venting system, wherein the outlet opens vertically downward.

In some aspects, the techniques described herein relate to a battery pack venting system, further including a vent in an enclosure wall of the traction battery pack, the vent configured to communicate the flow of vent byproducts received from the outlet to an area outside the traction battery pack.

In some aspects, the techniques described herein relate to a battery pack venting system, where the vent is a valve.

In some aspects, the techniques described herein relate to a battery pack venting method, including: communicating a flow of vent byproducts outward from one or more battery cells into an inner channel of a vent management member and against a divider wall of the vent management member; communicating the flow of vent byproducts through the inner channel in a first direction; redirecting the flow of vent byproducts into an outer channel; and communicating the flow of vent byproducts through the outer channel in a second direction to an outlet from the vent management member, the second direction opposite the first direction.

In some aspects, the techniques described herein relate to a battery pack venting method, further including communicating the flow of vent byproducts vertically downward through the outlet.

In some aspects, the techniques described herein relate to a battery pack venting method, further including communicating the flow of vent byproducts that have passed through the outlet through a vent in a battery pack enclosure to exhaust the flow of vent byproducts from a battery pack.

In some aspects, the techniques described herein relate to a battery pack venting method, wherein the one or more battery cells are in an upper tier of battery packs in a multi-tiered battery pack.

In some aspects, the techniques described herein relate to a battery pack venting method, wherein the inner channel has a C-shaped cross-sectional profile.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack according to an exemplary embodiment of the present disclosure.

FIG. 2 illustrates a perspective and partially expanded view of selected portions of the battery pack of FIG. 1.

FIG. 3 illustrates a schematic top view of the battery pack of FIG. 2.

FIG. 4 illustrates a section view taken at line 4–4 in FIG. 3.

FIG. 5 illustrates a perspective view of a vent management member from the battery pack of FIG. 2.

FIG. 6 illustrates another perspective view of the vent management member shown in FIG. 5.

FIG. 7 illustrates a section view taken at line 7–7 in FIG. 6.

### DETAILED DESCRIPTION

This disclosure details exemplary systems and methods utilized to communicate vent byproducts from battery cells to an area outside the battery pack. The systems and methods involve communicating the vent byproducts in ways that lengthen a time the vent byproducts are contained within the battery pack before the vent byproducts are exhausted from the battery pack. Increasing the time that the vent byproducts spend inside the battery pack can help to reduce thermal energy within the vent byproducts before those vent byproducts are exhausted from the battery pack. These and other features are discussed in greater detail in the following paragraphs.

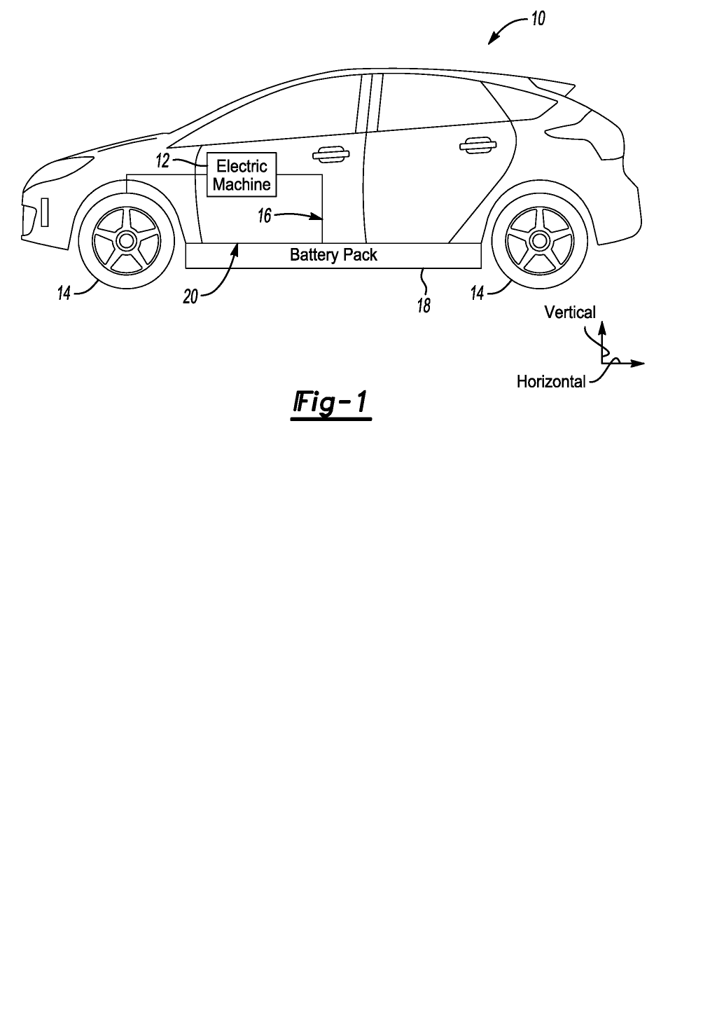

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEVs), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 electrically couples the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 is secured to an underbody 20 of the electrified vehicle 10. However, the traction battery pack 18 could be located elsewhere on the electrified vehicle 10 in other examples.

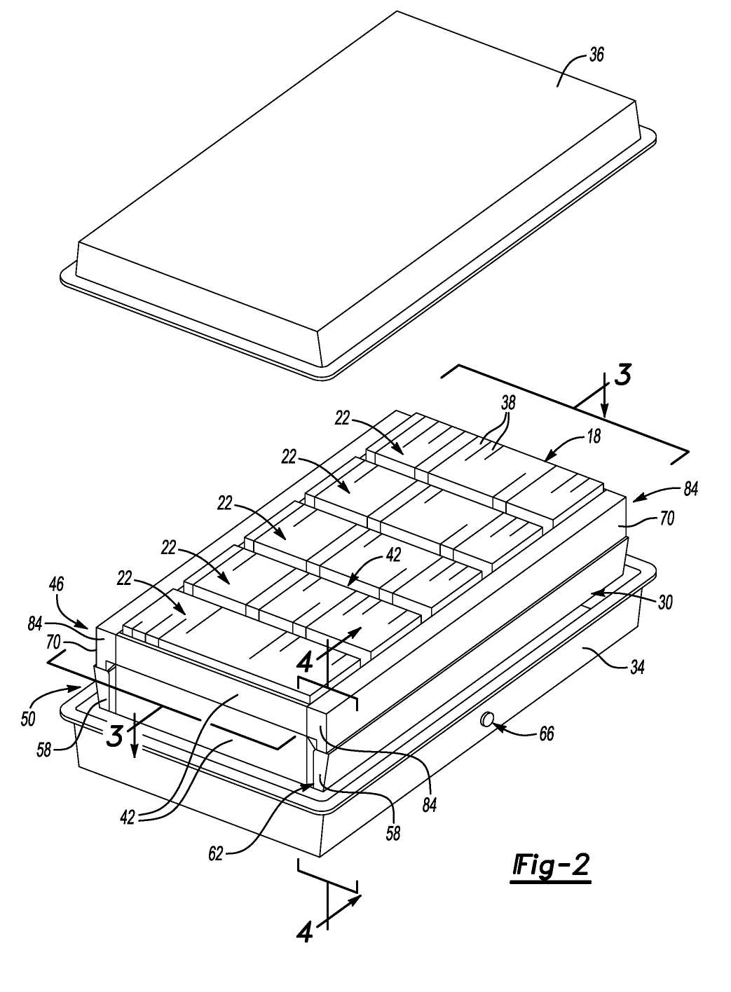

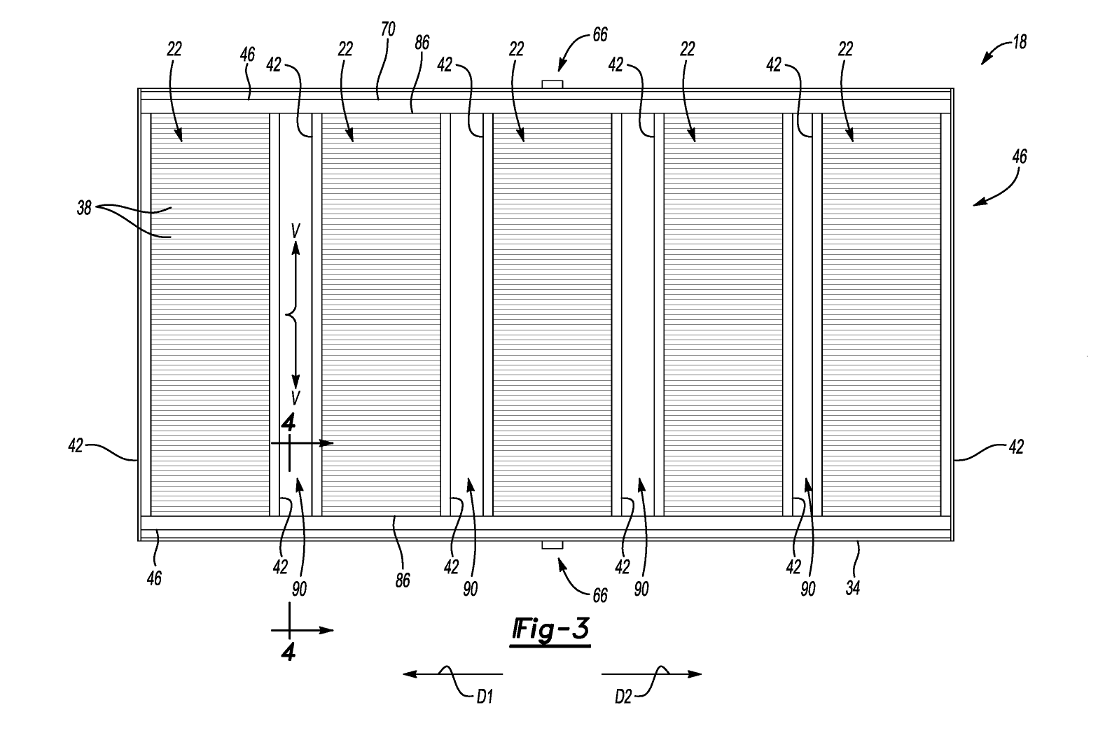

With reference to FIGS. 2-4, the traction battery pack 18 includes a plurality of cell stacks 22 housed within an interior area 30 of an enclosure. Here the cell stacks 22 fit within an enclosure tray 34, which can be secured to an enclosure cover 36, the underbody 20, or both to enclose the cell stacks 22 and other battery internal components within the interior area 30.

Each cell stack 22 includes a plurality of battery cells 38 stacked side-by-side relative to one another along a respective cell stack axis A. The battery cells 38 store and supply electrical power for powering various components of the electrified vehicle 10.

In the exemplary embodiment, the battery cells 38 are lithium-ion, pouch-style battery cells. However, battery cells having other geometries (cylindrical, prismatic, etc.) and/or chemistries (nickel-metal hydride, lead-acid, etc.) could alternatively be utilized within the scope of this disclosure.

The cell stacks 22 can additionally include dividers, thermal interface materials, adhesives, and other materials between the individual battery cells 38. Although a specific number of the cell stacks 22 are illustrated in the various figures of this disclosure, the traction battery pack 18 could include any number of the cell stacks 22.

In this example, the battery cells 38 of each of the cell stacks 22 are positioned between a pair of cross-member assemblies 42 such that the battery cells 38 are alongside the cross-member assemblies 42. The cross-member assemblies 42 described herein are configured to increase the structural integrity of the traction battery pack 18.

In an embodiment, the cell stacks 22 and the cross-member assemblies 42 extend longitudinally in a cross-vehicle direction of the electrified vehicle 10. However, other configurations are contemplated within the scope of this disclosure.

From time to time, pressure and thermal energy within at least one of the battery cells 38 in the cell stacks 22 can increase. This can lead to the battery cell 38 discharging a flow of vent byproducts, which can include gas and debris. The vent byproducts can be discharged from the battery cell 38 through a designated cell vent within a housing of the battery cell 38. The cell vent can be a membrane that yields in response to increased pressure and thermal energy within the battery cell 38. The cell vent can also be a ruptured area of the associated battery cell 38.

In this example, the battery pack 18 includes an upper tier 46 of cell stacks 22 and a lower tier 50 of cell stacks 22. The upper tier 46 is vertically above the lower tier 50. Vertical, for purposes of this disclosure, is with reference to ground in an general orientation of the battery pack 18 when installed within a vehicle. As the battery pack 18 includes both the upper tier 46 and the lower tier 50, the battery pack 18 can be considered a multi-tier battery pack.

Within the interior area 30, the upper tier 46 can be supported on a platform 54. A structural member 58 extends over ends of the cell stacks 22 of the lower tier 50. One of the structural members 58 is on a driver’s side of the cell stacks 22 on the lower tier 50. Another structural member 58 is on a passenger side of the cells stacks 22 on the lower tier 50. Open areas 62 are established between the structural members 58 and their respective sidewalls of the enclosure tray 34.

A vent 66 extends through the wall of the enclosure tray 34. Vent byproducts within the open area 62 can be exhausted from the battery pack 18 through the vent 66. The vent 66 can be a valve. In another example, the vent 66 is a pop off vent.

Vent management members 70 span the cell stacks 22 of the upper tier 46. One of the vent management members 70 is disposed on the driver’s side of the battery cells 38 in the upper tier 46. Another of the vent management members 70 is disposed on a passenger side of the cell stacks 22 in the upper tier 46. The vent management members 70 can be considered cell vent management (CVM) covers.

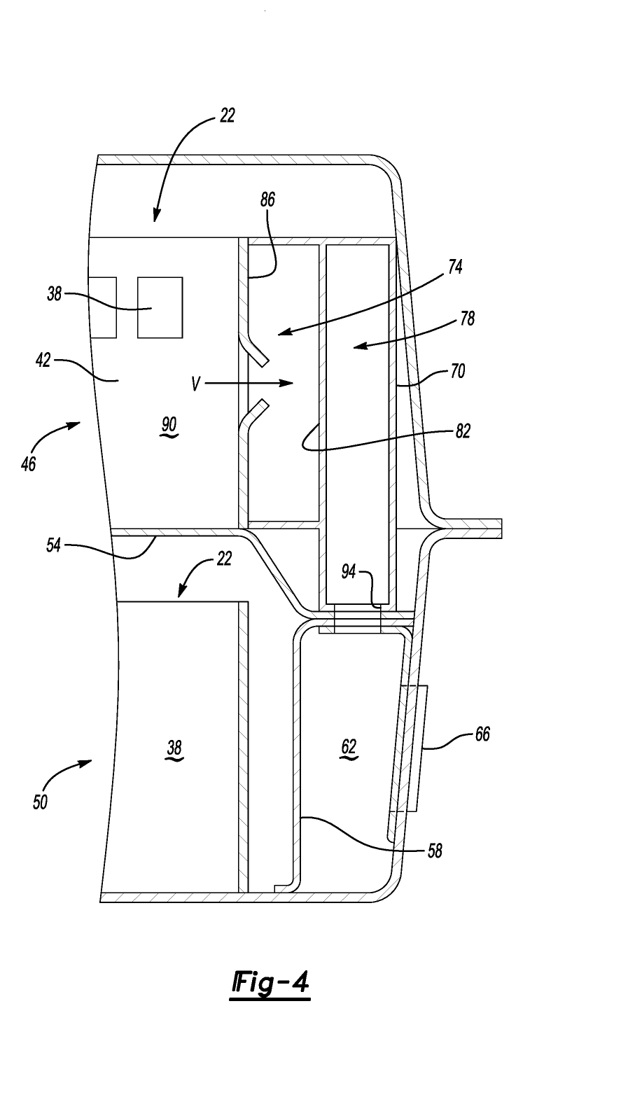

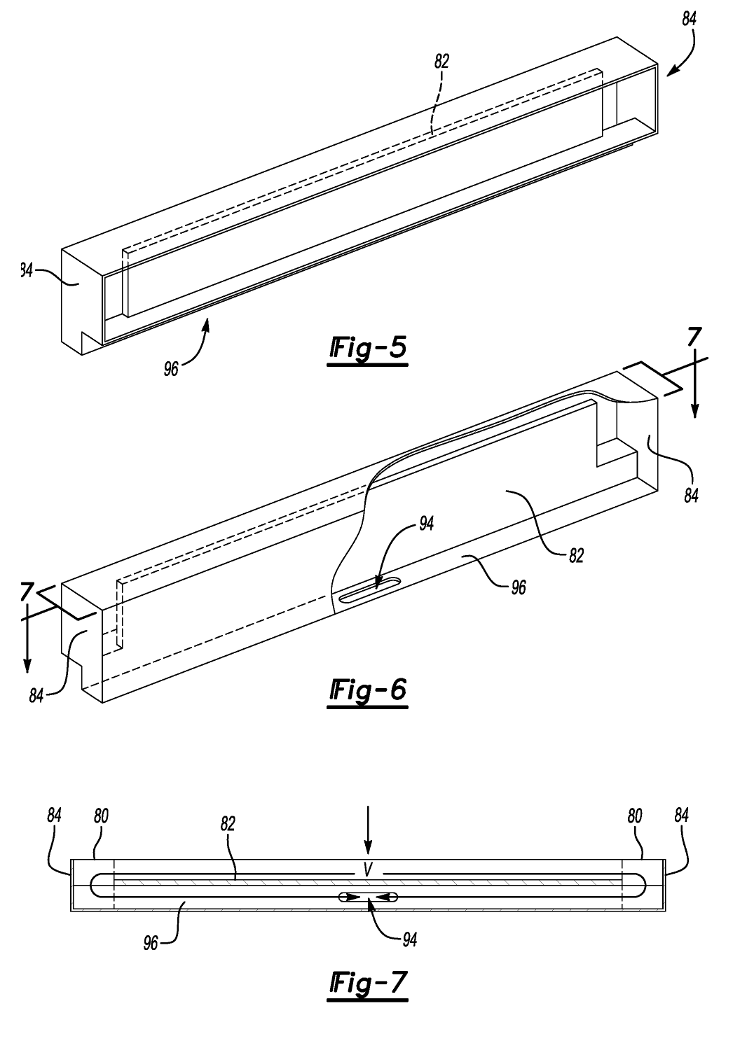

With reference not to FIGS. 5-7 and continuing reference to FIGS. 1-4, in this example, the vent management member 70 establishes an inner channel 74 and an outer channel 78. The example inner channel 74 opens to the cell stacks 22. The inner channel 74 generally has a C-shaped cross-sectional profile as shown in FIG. 4. The outer channel 78 has an O-shaped profile. The inner channel 74 is inboard of the outer channel 78.

A divider wall 82 separates the inner channel 74 from the outer channel 78. The divider wall 82 does not extend an entire longitudinal length of the vent management member 70 in this example. Thus, at opposing axial ends of the vent management member 70, the inner channel 74 opens to the outer channel 78 around the axial ends of the divider wall 82. Endwalls 84 enclose each axial end of the vent management member 70.

The vent management member 70 can be an anodized aluminum. In an example, the vent management member 70 is extruded, or portions of the vent management member 70 are extruded.

In some examples, to simplify manufacturing of the vent management member 70, the vent management member 70 could include endcaps 80 (see broken lines in FIG. 7) at the axial ends of the vent management member 70. The endcaps 80 can provide the endwalls 84 that enclose the axial ends and facilitate redirecting the vent byproducts V from the inner channel 74 into the outer channel 78. The endcaps 80 can omit the divider wall 82 leaving the inner channel 74 open to the outer channel 78 at the opposing axial ends of the vent management member 70. The endcaps 80 could be fastened to the other portions of the vent management member 70. A person having skill in the art and the benefit of this disclosure could potentially develop other ways to redirect vent byproducts from the inner channel 74 to the outer channel 78.

Sandwiched between the vent management member 70 and the cell stacks 22 on the upper tier 46 is a barrier—here a mica sheet 86. In this example, vent byproducts V from the battery cells 38 of the upper tier 46 are initially discharged through openings in the cross-member assemblies 42 into an open area 90 between cross-member assemblies 42. The vent byproducts V then flow, in this example, outward away from a centerline of the vehicle 10 toward the mica sheet 86.

In another examples cell stacks 22 could be oriented differently and the cross-member assemblies 42 omitted. The cell stacks 22 could, for example, include cells 38 disposed along an axis that is parallel to a longitudinal axis of the vent management member 70. The cells 38 could vent outward directly into the inner channel 74 rather than through the cross-member assembly 42 into an open area between cell stacks 22. In such an example, the vent management member 70 could be connected to endplates of the cell stacks 22.

The vent byproducts V can lift a flap or rupture an area of the mica sheet 86 and move into the inner channel 74. The vent byproducts V moving outboard into the inner channel 74 eventually contact the divider wall 82 and is redirected in a first direction D1 or a second direction D2 along a longitudinal axis of the vent management member 70. In this example, the first direction D1 is a direction forward in the vehicle 10 and the second direction D2 is a direction toward the rear of the vehicle 10.

The vent byproducts V moving in the first direction D1 or the second direction D2 eventually reach the endwall 84. At this position, the vent byproducts V are redirected and turned into the outer channel 78 around the axial ends of the divider wall 82. The vent byproducts V then flow in an opposite direction through the outer channel 78. That is, flow that has moved through the inner channel 74 in the first direction D1 is redirected by the endwall 84 into the outer channel 78 and then flows through the outer channel 78 in the second direction D2.

The vent byproducts V flow through the outer channel 78 and eventually reach an outlet 94 from the outer channel 78 and from the vent management member 70. In this example, the outlet 94 is an opening in a downward facing side 96 of the vent management member 70. The outlet 94 opens to the open area 62 between the structural member 58 and the wall of the tray 34. Vent byproducts V that have passed through the outlet 94 move vertically downward into the open area 62. After the vent byproducts V are in the open area 62, the vent byproducts V can exit from the battery pack 18 through the vent 66.

Thermal energy in the vent byproducts V dissipates as the vent byproducts V moves through the inner channel 74 and the outer channel 78 of the vent management member 70. In this example, the anodized aluminum material of the vent management member 70 can act as a heat sink to facilitate thermal energy transfer from the vent byproducts V. Routing the vent byproducts V through the vent management member 70 in multiple directs lengthens a time before the vent byproducts V exit the battery pack 18 and gives thermal energy within those vent byproducts V additional time to dissipate prior to being exhausted from the battery pack 18 through the vent 66. Thus, when the vent byproducts V exit the battery pack 18, a temperature of the vent byproducts V has been reduced. Due to the multiple redirections of the vent byproducts V, the vent byproducts V can be characterized as moving through the battery pack 18 along a tortious path.

Features of the disclosed examples include lengthening a time vent byproducts move through a battery pack prior to exhausting the vent byproducts from the battery pack.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack venting system, comprising:
one or more cell stacks of a traction battery pack; and
a vent management member having a divider wall that separates an inner channel of the vent management member from an outer channel of the vent management member, the inner channel opening toward the cell stack, the inner channel configured to communicate a flow of vent byproducts in a first direction to a position where the flow of vent byproducts can move around the divider wall from the inner channel to the outer channel, the outer channel configured to communicated the flow of vent byproducts in an opposite, second direction to at least one outlet from the vent management member.

2. The battery pack venting system of claim 1, wherein the inner channel is disposed between the outer channel and the one or more cell stacks.

3. The battery pack venting system of claim 1, wherein the inner channel is configured to receive a flow of vent byproducts from an area between a pair of cross-member assemblies.

4. The battery pack venting system of claim 1, wherein the vent management member is an extruded structural member.

5. The battery pack venting system of claim 1, wherein the vent management member spans a plurality of cell stacks.

6. The battery pack venting system of claim 1, wherein the vent management member extends longitudinally along a vent management member axis, the first direction and the second direction extending along the vent management member axis.

7. The battery pack venting system of claim 1, further comprising a first endcap and a second endcap disposed at opposing axial ends of the vent management member, the first endcap and the second endcap each configured to redirect a flow of vent byproducts from the inner channel into the outer channel.

8. The battery pack venting system of claim 1, wherein the inner channel has a C-shaped profile.

9. The battery pack venting system of claim 1, wherein the inner channel is inboard the outer channel.

10. The battery pack venting system of claim 1, wherein the outlet is in a vertical bottom side of the vent management member.

11. The battery pack venting system of claim 1, wherein one or more cell stacks are upper tier cell stacks of a multi-tiered battery pack.

12. The battery pack venting system of claim 11, wherein the outlet opens vertically downward.

13. The battery pack venting system of claim 12, further comprising a vent in an enclosure wall of the traction battery pack, the vent configured to communicate the flow of vent byproducts received from the outlet to an area outside the traction battery pack.

14. The battery pack venting system of claim 13, wherein the vent is a valve.

15. A battery pack venting method, comprising:
communicating a flow of vent byproducts outward from one or more battery cells into an inner channel of a vent management member and against a divider wall of the vent management member;
communicating the flow of vent byproducts through the inner channel in a first direction;
redirecting the flow of vent byproducts into an outer channel; and
communicating the flow of vent byproducts through the outer channel in a second direction to an outlet from the vent management member, the second direction opposite the first direction.

16. The battery pack venting method of claim 15, further comprising communicating the flow of vent byproducts vertically downward through the outlet.

17. The battery pack venting method of claim 15, further comprising communicating the flow of vent byproducts that have passed through the outlet through a vent in a battery pack enclosure to exhaust the flow of vent byproducts from a battery pack.

18. The battery pack venting method of claim 15, wherein the one or more battery cells are in an upper tier of battery packs in a multi-tiered battery pack.

19. The battery pack venting method of claim 15, wherein the inner channel has a C-shaped cross-sectional profile.
